(19) United States
(12) Patent Application Publication
(10) Pub. No.: US 2024/0354815 A1
(43) Pub. Date: Oct. 24, 2024

(54) Real-Time Visual Quoting System

(71) Applicants: Shona Jean Sinisi Bascon, Houston, TX (US); Sandeep Seth, Houston, TX (US)

(72) Inventors: Shona Jean Sinisi Bascon, Houston, TX (US); Sandeep Seth, Houston, TX (US)

(21) Appl. No.: 18/231,145

(22) Filed: Aug. 7, 2023

Related U.S. Application Data
(60) Provisional application No. 63/461,444, filed on Apr. 24, 2023.

(51) Int. Cl. G06Q 30/02; G06Q 30/0601; G06T 11/00; H04N 5/77

(52) U.S. Cl. CPC G06Q 30/0278; G06Q 30/0621; G06T 11/00; H04N 5/772; G06T 2200/24; G06T 2210/04

(57) ABSTRACT

A visual quoting system that includes a client device and a server connected to a database containing product and price quoting data for various window treatments as well as 3-D image and animation files. The client device includes a camera and user interface and obtains a real-world video stream of a room having windows and a user interface to receive user selections for the windows or window banks for which window treatment is desired along with window treatment pre-selections for type, color, material, components, and manufacturer. The client device communicates the dimensions and preferences to the server, which uses them to query the database for responsive options. The server sends product, pricing, and 3-D image data to the client device. The client device obtains a user selection of a responsive option and inserts the 3-D image data for that option into the real-world video stream showing the option in the room at the location of the selected window or window bank. The client device records a real-world video capture of the room with the inserted 3-D image contained therein, including at various light conditions and points of view, and an animation of the window treatment going between an open and closed position. The client device communicates a link to the recorded video along with a prepared quote to the customer for signature and purchase.

### BACKGROUND

The global market for window coverings is estimated to be over $31,000,000,000 in 2021 and is seeing continued expansion at an annual grown rate of 7.6%. See, e.g., https://www.grandviewresearch.com/industry-analysis/window-covering-market. Further, smart window treatments such as internet connected remotely controlled shades, blinds, and curtains are becoming more popular, further increasing market size. This increase is also attributable to other technological innovations, such as solar-blocking curtains and newer designs of blinds, which not only provide better temperature and light control but also decrease household energy consumption. And more than 8,000,000 new homes were sold in the United States alone in 2020 beyond the more than 5.5 million existing residences that may require window treatments.

The typical current process for obtaining window coverings is multi-stepped, time-consuming, inefficient, and complicated. Typically, the purchaser will have to visit a retail store to obtain samples that they will have to bring home to try to visualize a given window treatment, or have a dealer come to their homes with the samples in an attempt to see available treatments. They will pick one or more suppliers and take home a book of samples for those suppliers. The samples are typically of a small size and the homeowners are forced to use a great deal of imagination to try to determine how a particular treatment will aesthetically appear into a particular space given a particular texture or color or style as well as how it will function. This is particularly difficult when trying to further understand how the top treatment and bottom treatment will look as well as how the window treatments will block the light given the direction the windows are facing and various external light conditions.

Then having made some product choices, they will typically have to make an appointment to have their windows measured, involving further interaction with the retail store. Once some agent of the supplier or retail store has come to measure their windows, the customer must then engage in further interactions with the store/supplier to determine which window treatment preferences are actually available for their actual window sizes and which ones of those they would like to have quoted. In this process, the store/supplier may have to contact the manufacturer to confirm that they can fabricate the chosen window treatments to the consumer's particular widow sizes. If the client's preferences are not available for the customer's window sizes, the consumer has to then make an alternate choice that has to be confirmed by the store/supplier with the manufacturer. Presuming the supplier can fabricate the chosen product to the window sizes, the store must then send a quote so the consumer can decide whether the ultimate price is acceptable or yet another alternative must be chosen. Finally, a day comes when the custom manufactured window treatments arrive and are installed. And only then does the consumer know whether they actually like their choice and whether its appearance and functionality in the actual room matches the imagined appearance and functionality.

In particular, clients have extreme difficulty visualizing a pattern as applied to a soft window treatment such as a drapery, valance, cornice, or swag. Drapery styles such as a three pinch pleat, two pinch pleat, reverse pleat, box pleat, grommet, ripplefold or inverted pleat are extremely difficult for the client to visualize. Even hard window treatments such as blinds, shades and shutters are difficult for the client to grasp a final look of when applied to their windows in their particular room. It is beneficial if the client can understand how light will interact with the window treatments including light gaps in their particular environment and window configuration.

To make the experience easier on the buyer, more efficient for the seller, and to increase probability of the customer's satisfaction with their (non-returnable) choices of customized window covering systems, a system and method for real-time visual quoting of window treatments in accordance with the present disclosure is needed.

### BRIEF DESCRIPTION OF THE DRAWINGS

These drawings illustrate certain aspects of some examples of the present disclosure and should not be used to limit or define this disclosure.

FIG. 1 is a block diagram of a space requiring window treatments and illustrating the use of a portable client device used in obtaining a real-world video stream of the space, in accordance with one or more embodiments of this disclosure.

FIG. 2 is the block diagram of the space of FIG. 1 showing various user selected windows for which the client device has calculated dimensional measurements, in accordance with one or more embodiments of this disclosure.

FIG. 3 illustrates several software subcomponents of the client application installed on the portable client device, in accordance with one or more embodiments of the disclosure.

FIG. 4 illustrates a central server in network communication with the portable client device, in accordance with one or more embodiments of the disclosure.

FIG. 5 illustrates several subcomponents of the central server applications, in accordance with one or more embodiments of the disclosure.

FIG. 6 illustrates a window treatment database, in accordance with one or more embodiments of the disclosure.

FIG. 7 illustrates process flow between the client device and central server with which it communicates over a network, in accordance with one or more embodiments of the disclosure.

FIG. 8 illustrates additional process flow between the client device and central server with which it communicates over a network, in accordance with one or more embodiments of the disclosure.

FIG. 9 illustrates further process flow at the client, in accordance with one or more embodiments of the disclosure.

FIG. 10 illustrates a real-world video stream of the room with the 3-D files of selected window treatments inserted therein for recording.

### DETAILED DESCRIPTION

The following discussion is presented to enable a person skilled in the art to make and use embodiments of the present disclosure. Various modifications to the illustrated embodiments will be readily apparent to those skilled in the art, and the principles herein can be applied to other embodiments and applications without departing from embodiments of the present disclosure. Thus, the embodiments are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the embodiments. Skilled artisans will recognize that the examples provided herein have many useful alternatives and fall within the scope of the embodiments.

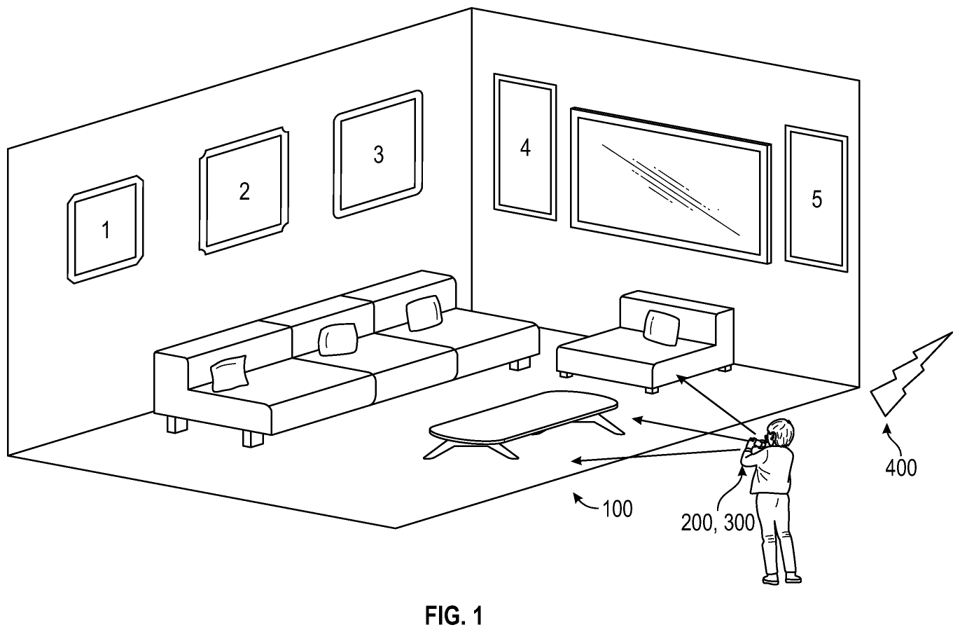

Referring now to the drawings, in accordance with one or more embodiments of the disclosure used to illustrate the principles and operation of the present system and method, FIG. 1 is a block diagram of an example physical space 100, such as room in a house, for which a customer desires window treatments. Space 100 includes Windows 1-5. Windows 1-3 are defined in a first wall and Windows 4-5 are defined in a second wall. A representative of a window treatment company (e.g., a retail store or supplier) is depicted using a client-side application 200 installed and operating on client device 300, here a portable network enabled computer including a processor, video card, WAN connectivity, camera, and display, such as an Apple® iPad® connected over the internet to a system central server 500.

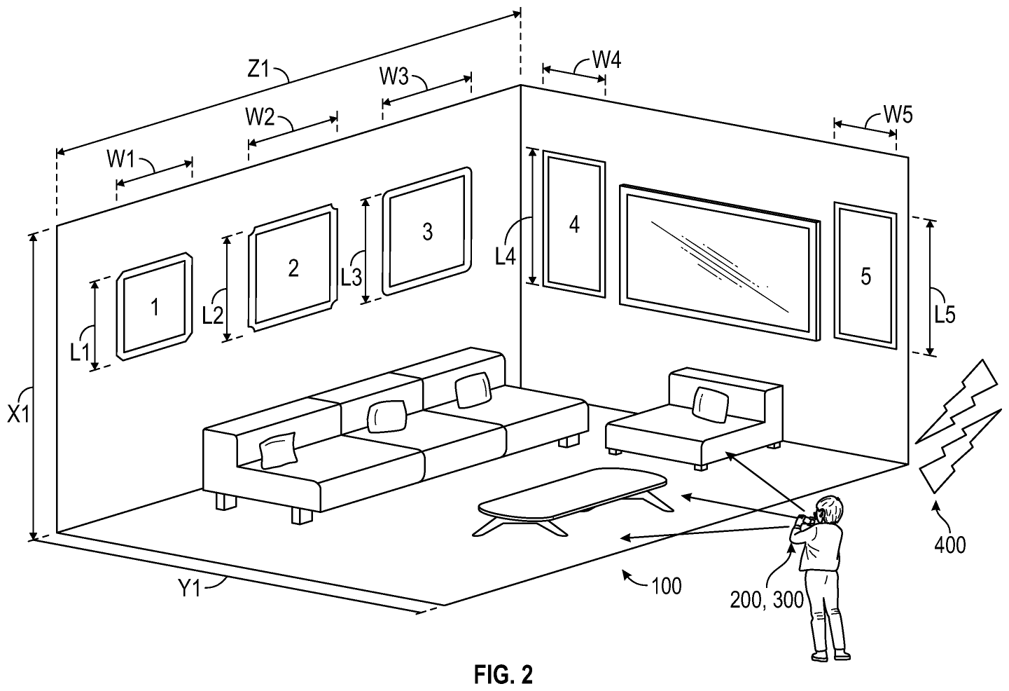

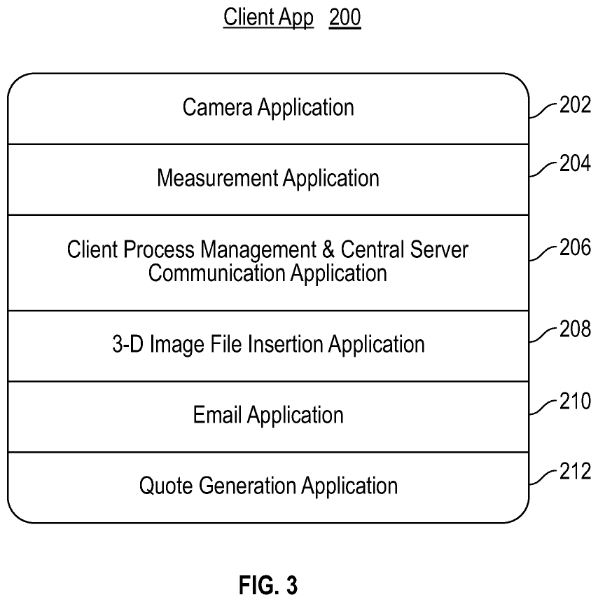

Referring now to FIGS. 2 and 3, the client application 200 includes various sub-applications, the operation of which will be described. A camera application 202 operates with the camera of client device 300 and provides a real-world video stream to the device's display and records and stores two-dimensional still images and two-dimensional and three-dimensional video of the real-world video stream. Using the camera application, the user can point the device's camera at the subject space 100 and see the room on the video display and, in a “walk-through” mode, record a real-time video including different views of the space.

As shown in FIG. 3, the client application 200 includes a user interface module (not depicted) (“UI”) that provides user interactivity via the display of the client device 300, preferably a touch screen. The UI displays menus allow the user to input selections of one or more windows for which window treatments are desired and communicates the user input to the measurement application 204 and the process management & server communication application 206. The client process management application 206 assigns a window identifier to each selected window. The measurement application 204, using the device, calculates for the given window identifier the corresponding window's real-world dimensions and outputs its measurements to the process management application 206. The measurement application 204 also outputs to the UI any instructions that are necessary to be displayed for the user to procure an accurate measurement, for example for the user to point the camera of the client device 200 more normally to the window whose dimensions are being measured or to select the window's boundaries. The measuring application may, in calculating the measurements, incorporate functionality utilized in pre-installed applications, such as the “Measure app” provided for certain Apple® iPads®.

For each user selected window space, the process management application 206 presents to the UI pre-selection menus that allow the user to input window treatment preferences for the user to select, such as the type of window treatment, the desired manufacturer, the window treatment operating system, material, or color. The UI may also present other customization parameters that may affect the visualization of window treatments, such as the compass direction the window faces or an outside light intensity level. The pre-selections offered by the system are based upon the product data contained in the given manufacturer's databases. To be clear, the UI options provided at the client application 200 will be pre-populated based upon the database data.

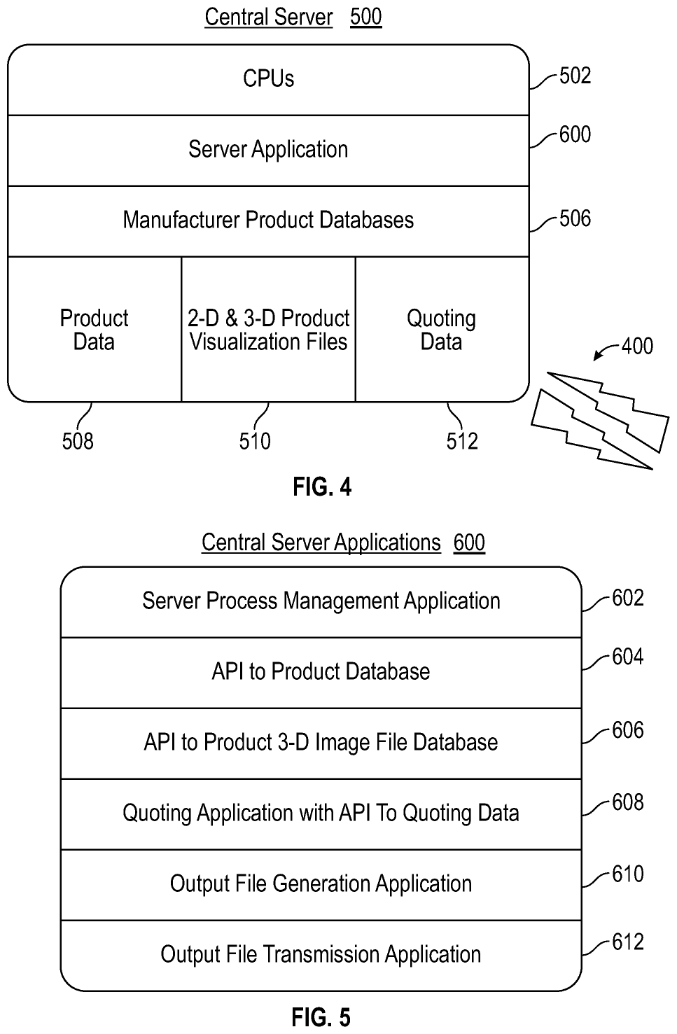

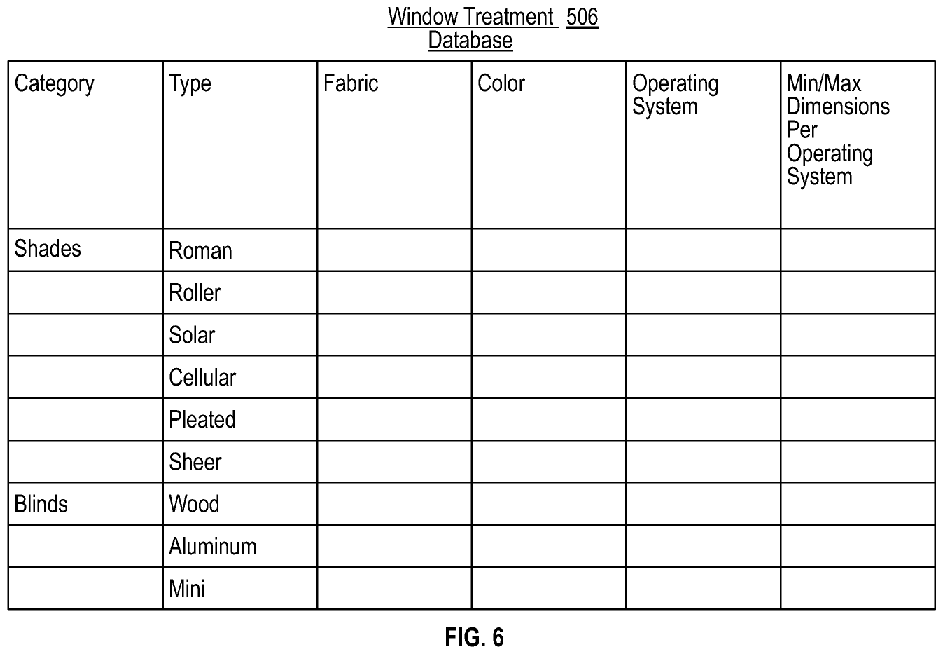

The client process management & central server communication application 206 packages the user pre-selection and dimensional data into an input file (not depicted) and transmits it from the client device 300 to the central server 500. As shown in FIG. 4, the central server 500 comprises one or more computer processors 502 that run a package of server applications 600. The server 500 host is connected to window treatment product databases 506 of one or more manufacturers or suppliers. As shown in FIG. 6, the window treatment databases 506 include product data 508, 2-D and 3-D product image files 510, and Quoting Data. The database includes category, type, available fabric, color, operating system, and dimensional data, for example, in addition to pricing data.

Turning to FIG. 5, a server process management application 602 parses the input file received from the client for the user pre-selections and dimensional data contained therein and queries one or more responsive manufacturer product database 506 for the manufacturer selection(s) indicated in the input file via application programming interface API 604 using the user pre-selections for that manufacturer and the dimensional data from the input file. For example, as shown in FIG. 6 the UI may have presented the user with options for the window treatments to be shades or blinds. If the user selects shades, the UI further allows the user to pick one or more of the following types of shades: Roman, Roller, Solar, Cellular, Pleated, or Sheer. If the user selects, for example, “Roller”, the UI offers the user to select additional preferences such as manufacturer, fabric, color, desired functional or aesthetic components, and type of operating system. The API 604 returns product data 508 for one or more responsive window treatment options. The server processing application 602 also uses API 606 to query the 2-D and 3-D product visualization file database 510 for animation and visualization data files for the one or more responsive options, which include data allowing a video card to show an amination of the window treatment opening or closing. The API 606 returns the responsive image files to the server processing application 602, which in turn uses the output file generation application 610 to assemble an output file (not depicted) which includes both the product data and product image files for the one or more responsive options. The server processing application 602 then calls the output file transmission application 612 to transmit the output file to the client device 300 for further processing by the client application 200.

The client process management application 206 of the client device 300 receives the output file from the central server 500 over the WAN 400, parses the output file, and caches the received data for the options returned from the one or more manufacturer product database(s) 506. The client process management application 206 creates a UI presenting a thumbnail picture and summary information for each option. In response to a user selection of a window treatment option, the client process management application 206 calls the image file insertion application which, working with the video card of the client device 300, inserts the 3-D image file of the selected window treatment option into the real-world video stream of the room for display overlayed at the boundaries of the selected window or bank of windows. Once the selected window-treatment option is displayed in real-world video feed, the UI provides options for the user to activate the animation of the opening and closing of the window treatment and to show its translucency and color appearance in various user adjustable light conditions in an open or closed or in between position. In this regard, the client process management application 206 interfaces with both the video card and the camera application to change the visual depiction of the window treatment based upon product specific data regarding its color, material, and thickness from the output file. The “walkaround” mode allows the user to record a video capture of the display showing the 3-D file of the selected window treatment from various angles around the room and in the different light conditions, as well as recording the animation of its opening and closing. Upon the user input, the client process management application 206 transmits the recorded video file to the central server 500 for storage. The output file transmission application 612 then prepares and transmits a file with the HTTP link to the stored video for the email application 210 at the client device 300 for the user to later use or provide to the customer.

If the customer rejects a given window treatment option, the user returns to the UI screen displaying the thumbnails of the options for the customer to select another option, and the process previously described in the prior paragraph is repeated with the new selected product inserted into the video stream so that its appearance and operation can be animated to the user from various angles and in various light conditions and colors. Once the customer selects that option for quoting, the client device 200 transmits a copy of the video stream file to the central server 500 for storage and a link is returned.

Once all the final selections are made of window treatments, colors, fabrics, and operating systems for each of the various windows or sets of windows, the client process management application 206 prepares a quote input file (not depicted) that includes the final selections and transmits the file to the central server 500. The central server 500 parses the quote input file and passes it to the quoting application 608, which queries the quoting data 512 in the product database 506 to retrieve the pricing, ordering, and scheduling data. This data also may be maintained by the manufacturer in a separate database in communication with the central server 500 or hosting on the central server itself and periodically updated. Once the quoting data has been retrieved for the selected window treatment(s), the server processing application 602 prepares a quote output file (not depicted) which the output file transmission application 612 sends to the client device 300.

Once the client device 300 has received the quote output file, the quote application 212 parses the file and generates a quote in a selected format. The quote contains the pricing, ordering, and delivery information for the selected window treatment selections for each window or bank of windows, along with the respective link of the video file. The quote may also contain a 2-D custom thumbnail screenshot of the window treatment projected onto the respective window or bank of windows inserted into the real-world video capture of that window or window bank as a reminder to the customer. Once the quote file is prepared, the email application 210 prepares an email to the customer containing both the quote and the links to the custom video capture showing the animations of the selected window treatments inserted into the real-world video feed of the room space. Conventionally, the client device 300 may include a LAN connection to a wireless printer so that the quote and links may also be printed and given to the customer in hardcopy form. Alternatively, or additionally, the client device 300 may include an electronic mail and electronic document signing application so that the quote and links may be emailed to the customer for electronic signature.

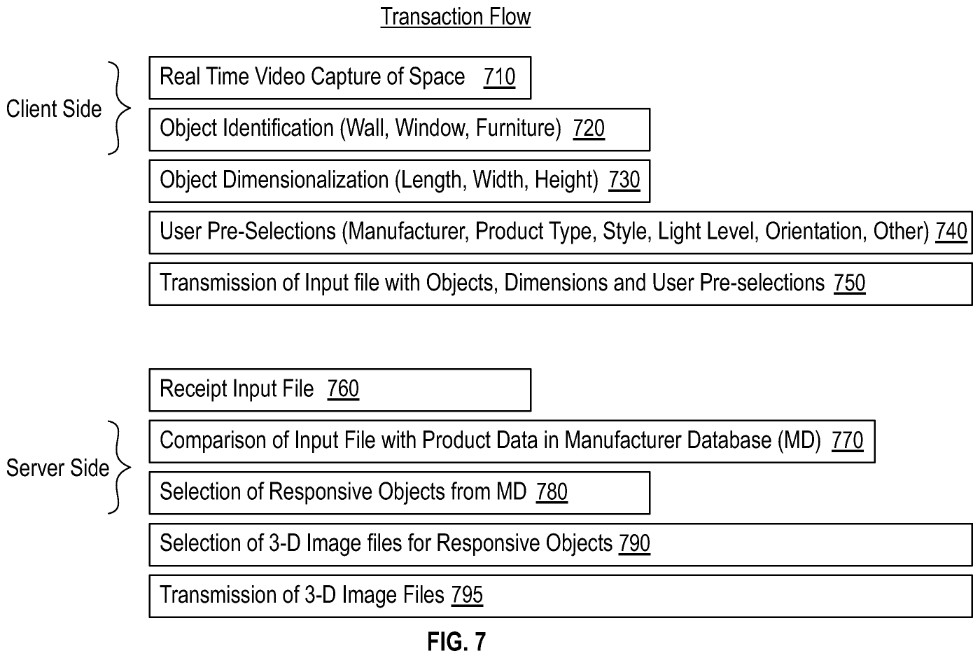

As shown in FIG. 7, the transactional flow for a preferred embodiment of the present invention begins with step 710 and uses the portable client device 200 to capture a real-time video stream of a room having at least one window or bank of windows. The portable device includes an object recognition application and executes the application at step 720 to identify within the real-time video stream the windows or window banks and their respective boundaries and projects identifiers and lines depicting the boundaries on a user interface on the display of the portable client device. The user interface allows the user to select the window or bank of windows for which a visual price quote is desired. Upon such selection, at step 730, a measurement application obtains preliminary dimensions of the selected window bank by either calculating a preliminary height and width measurement for each selected window/window bank using the boundaries determined by the object recognition application or by manual input. At step 740, the user interface projects a menu of selectable general window treatment options such as the manufacturer, product type/style, light blocking level, orientation, and other general window treatment options. At step 750, the client management application 206 packages the obtained preliminary measurements user pre-selections into an input message file and transmits them to the server 500.

As also depicted in FIG. 7, at step 760 the server 500 receives the input message file and parses the data contained therein for the preliminary dimensions and user pre-selections. At step 770 the server uses the parsed data as input for a query to the product databases 506 to identify product data 508, 2-D & 3-D product visualization files 510, and quoting data 512 for responsive window treatment options, including the respective components for each such option. At steps 780 and 790, the server 500 selects identified product data 508, visualization files 510, and quoting data 512 for a plurality of responsive options based upon arbitrary criteria left open to the system designer. For example, the pre-selection criteria may also include price ranges and the window treatment options may be selected based thereupon to be in the upper or lower end of the range. Alternatively, some responsive window treatment styles may be given a higher weighting based upon other criterial such as a preferred manufacturer or style. Once the selection criteria is supplied, the server creates a response message for transmission to the portable client device 200 with at least the 3-D visualization files for presentation to the user.

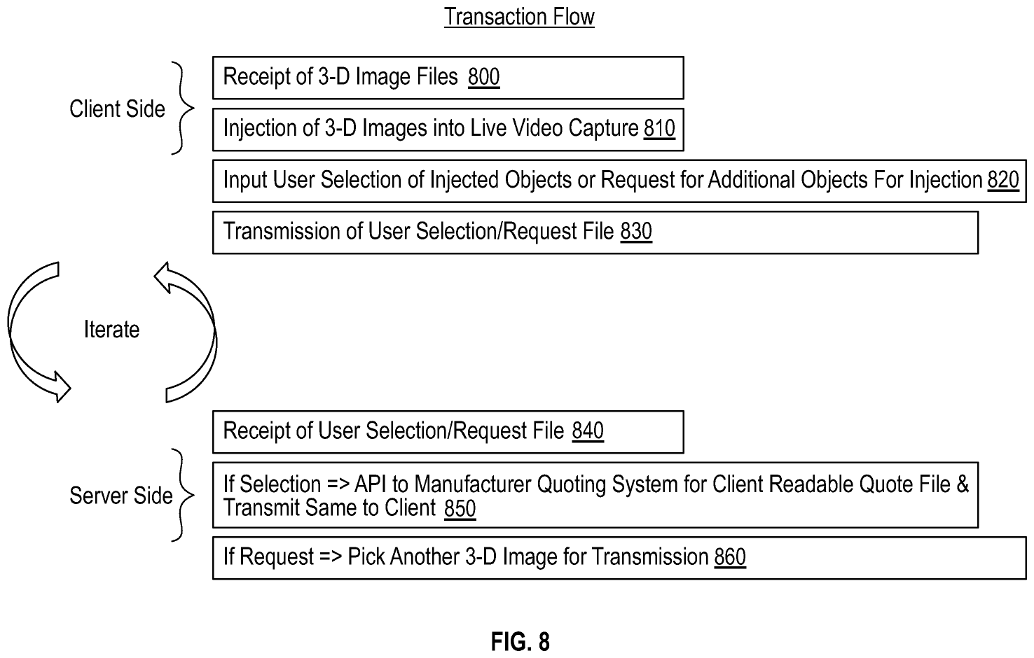

As depicted in FIG. 8, at step 800 the client receives the 3-D image files, which preferably include animation data and 2-D images. The client management application 206 first presents a user interface and displays 2-D image files of a plurality of selected options (that fit the pre-selections and preliminary dimension criteria) and presents thumbnails for the user to select which one they would like to see first. The client management application 206 then, at step 810, accesses the 3-D visualization and animation data and injects into the live video stream a visualization of the selected window treatment option for display on the screen of the portable client device 200. Using a recording function, the user can then record a video showing the selected window treatment option at various perspectives. A user interface allows the user to activate the animation to record the selected window treatment option opening and closing. The user interface also allows the user to change the light conditions so that the recorded video also shows the translucency of the selected window treatment options at different times of the day or night.

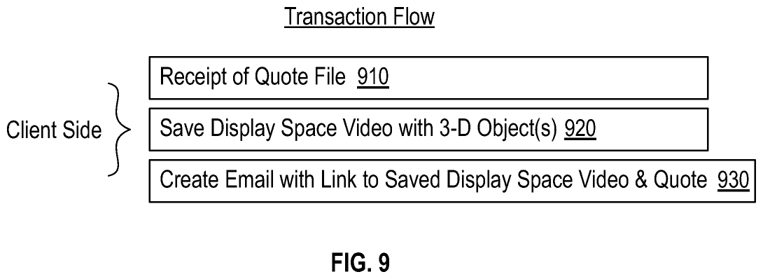

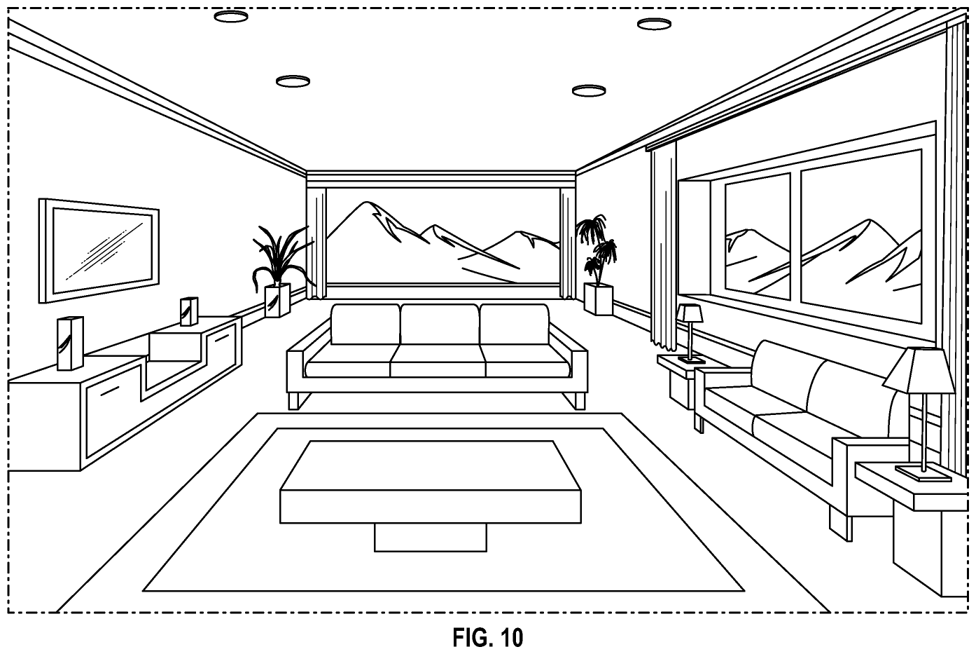

In one embodiment, the server 500 sends data for one window treatment option at a time to the portable client device 200. In this embodiment, at steps 820 and 830, the user is presented one option at a time to view from different perspectives in the real-time video stream and then can choose to receive additional options to have presented/recorded in the real-time video stream. In this embodiment, the user can select, at step 820, an additional option to be presented in the real-time video stream for recording. Under this option, the server 500 identifies and transmits back to the client the visualization data for such additional option at step 860. Alternatively, at step 840, the user can indicate that a presented option is a final selection for which they wish to receive a quote. When any final selection is indicated as made in a message from the portable client device 200 or the server 500, at step 850, the server uses an API to the quoting system of the manufacturer of the selected window treatment option to generate a quote that is transmitted to the portable client device. In one embodiment, the portable client device transmits to the server the recorded video for the selected option where it is stored. The server process management application 602 creates a link to the video file and inserts it into the price quote for transmission to the portable client device 200. As shown in FIG. 9, in another embodiment the portable client device 200 receives the price quote at step 910 and inserts its own link to the saved real-time video with the animation of the quoted window treatment option depicting it under various lighting conditions and points of view into the price quote at step 920. The linked priced quote is emailed to the customer at step 930.

As seen from the foregoing, the output of the process and system is a price quote for a selected window treatment that can be provided to a customer and that contains a link to a video file. The video file shows the quoted window treatment in the real-world room visualizing the selected window treatment as it would appear as installed at a particular window or window bank, as depicted in FIG. 10. Moreover, the video may be shot from various perspectives, animate the translucency of the window treatments under various light conditions, and animate the opening and closing of the window treatment.

Thus, in brief summary, the process in accordance with the present disclosure generally includes (a) providing a client device connected to a window treatment database that includes both 2-D and 3-D visual files depicting window treatment products, as well as various product data such as manufacturer, type of window treatment, available material, color, size, components, and operating system options and pricing data for such options; (b) using a client device to obtain a video stream of a real-world space having windows; (c) providing a UI on the client device to allow for the pre-selection of real-world windows for which window treatments are desired; (d) using the video stream data to obtain preliminary dimensions for each of the selected windows or bank of windows; (e) providing a UI for the customer user to make pre-selections of various window treatment preferences for each selected window or bank of windows; (f) using the pre-selection and preliminary dimensions to query the product database for responsive window treatment options; (g) providing 2-D and 3-D image animation files for the responsive window treatment options; (h) providing a UI to allow the user to select a window treatment option for a selected window or bank of windows; (i) inserting the 3-D file(s) of a selected window treatment option into the real-world video stream at the respective window or bank of windows in the room to allow the user to visually “see” that option in the real-world video stream; (j) recording the video stream from various points with the animation showing the window treatment in operation, opening and closing and under various light conditions; (k) repeating steps (i)-(j) for other user selections; (l) providing a UI to allow the user to make final sections; (m) querying the database to obtain quoting information for the final selections; and (n) providing a link to the video files containing the window treatment animations for the various final selected options with the respective quote for those options.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof, to another element, it can be directly connected, coupled, or responsive to the other element, or intervening elements may be present. In contrast, when an element is referred to as being “directly connected”, “directly coupled”, “directly responsive”, or variants thereof, to another element, there are no intervening elements present. Like numbers refer to like elements throughout. Furthermore, “coupled”, “connected”, “responsive”, or variants thereof as used herein, may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof, are open-ended, and include one or more stated features, integers, elements, steps, components or functions but does not preclude the presence or addition of one or more other features, integers, elements, steps, components, functions or groups thereof.

Although several embodiments of inventive concepts have been disclosed in the foregoing specification, it is understood that many modifications and other embodiments of inventive concepts will come to mind to which inventive concepts pertain, having the benefit of teachings presented in the foregoing description and associated drawings. It is thus understood that inventive concepts are not limited to the specific embodiments disclosed hereinabove, and that many modifications and other embodiments are intended to be included within the scope of the appended claims. It is further envisioned that features from one embodiment may be combined or used with the features from a different embodiment(s) described herein. Moreover, although specific terms are employed herein, as well as in the claims which follow, they are used only in a generic and descriptive sense, and not for the purposes of limiting the described inventive concepts, nor the claims which follow. The entire disclosure of each patent and patent publication cited herein is incorporated by reference herein in its entirety, as if each such patent or publication were individually incorporated by reference herein. Various features and/or potential advantages of inventive concepts are set forth in the following claims.

What is claimed is:

1. A visual window treatment quoting method comprising:
(a) providing a portable client device including a camera, video card, processor, network transceiver, and display screen;
(b) providing a camera module programmed to run on the portable client device's processor with instructions to obtain and record a real-world video stream of a room having windows or banks of windows;
(c) providing a server having network communication with the portable client device, the server including one or more databases for a plurality of window treatment options, the one or more databases including for each window treatment option product data and visualization files;
(d) using the camera of the portable client device to obtain and record the real-world video stream of the room having one or more windows and to display the real-word video stream on the display screen of the portable client device; (e) providing a first user interface on the portable client device allowing a user to select one or more windows shown in the displayed real-world video stream for which window treatments are desired;
(f) obtaining preliminary height and width dimensions for each of the selected one or more windows;
(g) providing a second user interface on the portable client device allowing the user to input various window treatment preferences for each selected window;
(h) transmitting the window treatment preferences and the preliminary dimensions to the server;
(i) using the selected window treatment preferences and preliminary dimensions as inputs to query the one or more databases to identify one or more responsive window treatment options that respectively each include one or more window treatment components;
(j) transmitting from the server to the portable client device product data and one or more visualization files for at least one of the identified one or more responsive window treatment options;
(k) inserting visualization data from at least one visualization file into the real-world video stream of the room so that visualization data is superimposed into the real-world video stream such that the at least one responsive window treatment option, including its one or more components, is visualized at the respective one or more windows which it is to cover wherein when the portable client device is moved within the room both the visualization data and the real word video stream reflect the corresponding change of perspective in relation to the depiction of the window treatment option in the real-world video stream;
(l) recording the video stream including the visualization of the window treatment from a plurality of points of view; and
(m) providing access to the recorded video recording file in conjunction with a quote for the visualized window treatment option.

2. The method of claim 1, further comprising:
(a) using visualization data from the one or more visualization files to depict the visualization of the window treatment under various light conditions and/or to animate the opening or closing of the window treatment; and
(b) recording the real word video with the visualization of the window treatment under various light and/or with the animation of the opening or closing of the depicted window treatment.

3. The method of claim 1, wherein the preliminary dimensions of the windows or banks of windows are obtained by being calculated by the portable client device using data acquired from its camera.

4. The method of claim 1, wherein the preliminary dimensions of the window or banks of windows are obtained by being physically measured and input into the portable client device.

5. The method of claim 1, further comprising generating a quote for the depicted window treatment from price data stored in the database for that window treatment, including its components, and generating and inserting a link to the video recording into the quote.

6. A visual window treatment quoting system comprising:
(a) a portable client device having a camera, video card, processor, network transceiver and display screen;
(b) a camera module programmed to run on the portable client device's processor with instructions to obtain and record a real-world video stream of a room having one or more windows and to display the video stream on the display screen of the portable client device;
(c) a server including one or more databases for a plurality of window treatment options, the one or more databases including for each window treatment option product data and visualization files;
(d) a first user interface module programmed to run on the portable client device's processor with instructions to generate a user interface on the display screen of the portable client device allowing a user to select one or more windows shown in the displayed real-world video stream for which window treatments are desired and to input window treatment preferences for each selected one or more windows;
(e) a measurement module programmed to run on the client device with instructions to obtain or receive preliminary height and width dimensions for the one or more selected windows;
(f) a first communication module programmed to run on the client device with instructions to transmit the window treatment preferences and the preliminary dimensions to the server;
(g) a database management module programmed to run on the server with instructions to use the window treatment preferences and preliminary dimensions as inputs to query the one or more databases to identify one or more responsive window treatment options that respectively each include one or more window treatment components;
(h) a second communication module programmed to run on the server with instructions to transmit from the server to the portable client device product data and one or more visualization files for at least one of the identified one or more responsive window treatment options;
(i) a second user interface module running on the client device programmed to allow the user to select at least one window treatment option from the one or more responsive window treatment options communicated from the server to the client device;
(j) a visualization module programmed to run on the client device's processor with instructions to insert visualization data from at least one visualization file into the real-world video stream of the room so that visualization data is superimposed into the real-world video stream such that the at least one responsive window treatment option, including its one or more components, is visualized at the respective window or bank of windows which it is to cover wherein when the portable client device is moved within the room, both the visualization data and the real word video stream reflect the corresponding change of perspective in relation to the depiction of the window treatment option, so that a video recording can be made of the real-world stream including the visualization of the window treatments from a plurality of points of view by moving the portable client device within the room.

7. The system of claim 6, wherein said video module further includes instructions to use visualization data from the one or more visualization files to depict the window treatment under various light conditions and/or to animate the opening or closing of the depicted window treatment.

8. The system of claim 6, further including a third user interface programmed to run on the portable client device's processor with instructions to generate an interface allowing the user to select changes to the light conditions and/or to select a request animating the opening or closing of the window treatment.

9. The system of claim 6, wherein the measurement module instructions include instructions for calculating and storing the preliminary measurements using data acquired from the camera of the portable client device.

10. The system of claim 6, wherein the measurement module instructions include instructions for receiving and storing the preliminary measurements.

11. The system of claim 6, further comprising a quote generation module programmed to operate on said portable client device or server with instructions to generate a quote for the depicted window treatment from price data stored in the database for that window treatment, including its contents, and to generate a link to access the video recording to be provided in conjunction with a price quote.
